(19) United States
(12) Patent Application Publication
(10) Pub. No.: US 2007/0138863 A1
(43) Pub. Date: Jun. 21, 2007

(54) Modular Pedal Box Assembly

(76) Inventors: Warren Clark, Evans, GA (US); Aric Singletary, Hephzibah, GA (US); Donald S. Hanson, Augusta, GA (US); Bradley J. Hanson, North Augusta, SC (US)

Correspondence Address: HARNESS, DICKEY & PIERCE, P.L.C., P.O. BOX 828, BLOOMFIELD HILLS, MI, 48303, US

(21) Appl. No.: 11/163,844

(22) Filed: Nov. 1, 2005

(51) Int. Cl. B60T 8/86

(52) U.S. Cl. 303/125

(57) ABSTRACT

A modular accelerator and brake (A&B) assembly for controlling the movement of a utility vehicle is provided. The modular A&B assembly controls operation of a vehicle prime mover and braking assembly. The modular A&B assembly includes a mounting plate coupled to a frame structure of the vehicle. An accelerator pedal subassembly includes an accelerator pedal shaft that is rotationally mounted within a pair of opposing apertures in a pair of accelerator mounts extending from an underside of the mounting plate. A brake pedal subassembly includes a brake pedal shaft that rotationally mounted within a pair of opposing apertures in a pair of brake mounts extending from the underside of the mounting plate. The accelerator pedal shaft and the brake pedal shaft are mounted to the mounting plate such that an axis of the accelerator pedal shaft is offset from an axis of the brake pedal shaft.

### FIELD OF THE INVENTION

The present invention relates to control systems for light-weight utility vehicles such as golf cars. More particularly, the invention relates to a modular pedal box assembly for such a utility vehicle.

### BACKGROUND OF THE INVENTION

Known utility vehicle control systems include an acceleration control assembly and a braking control assembly arranged on a common shaft or along collinear shafts. The acceleration control assembly controls a primary mover that imparts motive forces on a drive wheel of the vehicle to affect movement of the vehicle. The braking control assembly typically controls operation of mechanical drum, shoe, and pad brake mechanisms or a mechanical steel band and polished drum brake mechanisms. The acceleration and braking assemblies typically bolt to a floor structure of the vehicle, are very bulky, and consist of a multitude of parts that add labor and tooling costs, complexity, and weight to the assemblies. Additionally, the location, height, angle and orientation of associated accelerator and brake pedals, with respect to a vehicle driver seated in a drivers seat of the vehicle, position the pedals such that use of the pedal is often awkward, uncomfortable and laborious for the driver.

Therefore, it is highly desirable to implement a vehicle control system that is less bulky, consists of fewer parts, is lighter, less complex, costs less to fabricate, install and maintain, and locates the accelerator and brake pedals in a more ergonomic position for the driver.

### BRIEF SUMMARY OF THE INVENTION

In various embodiments, the present invention provides a modular accelerator and brake (A&B) assembly for controlling the movement of a utility vehicle. The utility vehicle can be any small vehicle, such as a golf car, a maintenance car or a go-cart, having a motor for delivering torque to affect movement of the vehicle and a braking assembly adapted to apply frictional forces to impede rotation of at least one wheel of the vehicle. The modular A&B assembly controls operation of the motor and the braking assembly.

The modular A&B assembly includes a mounting plate having a lip formed around a perimeter of the mounting plate, wherein the lip is adapted to fit within a recess formed in a floor structure of the vehicle. When the modular A&B assembly is installed in the utility vehicle the mating of the lip and recess form a barrier to liquids, objects and debris penetrating a joint formed between the lip and the recess. The modular A&B assembly additionally includes an accelerator pedal subassembly comprising an accelerator pedal coupled to an accelerator pedal arm coupled to an accelerator pedal shaft that is rotationally mounted within a pair of opposing apertures in a pair of accelerator mounts extending from an underside of the mounting plate. The modular A&B assembly further includes a brake pedal subassembly comprising a brake pedal coupled to a brake pedal arm coupled to a brake pedal shaft that is rotationally mounted within a pair of opposing apertures in a pair of brake mounts extending from the underside of the mounting plate. In at least one embodiment, the brake mounts are formed by a U-channel housing mounted to the underside of the mounting plate. The accelerator pedal shaft and the brake pedal shaft are mounted to the mounting plate such that an axis of the accelerator pedal shaft is offset from an axis of the brake pedal shaft. That is, the axes of the accelerator pedal shaft and the brake pedal shaft are non-collinear.

The modular A&B assembly is adapted to mount to a frame structure of the vehicle such that the accelerator subassembly is located on one side of the frame structure and the brake subassembly is located on an opposing side of the frame structure. Mounting the modular A&B assembly to straddle the frame structure such that the accelerator and brake assemblies are located on opposing side of the frame structure allows the accelerator pedal to be ergonomically located a first orthogonal distance from a center line of the vehicle and the brake pedal to be ergonomically located a second orthogonal distance from the center. Therefore, the first and second orthogonal distances are strategically determined to ergonomically locate the pedals for a driver of the vehicle. That is, the driver's foot position, when operating the pedals, will be generally directly in front of the him/her such that he/she can sit comfortably in the driver's seat, facing forward and not feel like his/her body and legs need to be awkwardly twisted, angled toward a side of the vehicle, misaligned or need to exert undue effort or energy to operate the pedals. Additionally, the offset of the accelerator and brake axes is adapted to locate the accelerator pedal a first longitudinal distance from a driver seat base of the vehicle and the brake pedal a second distance from the driver seat base to thereby ergonomically locate the accelerator and brake pedals for the driver. Furthermore, the accelerator pedal is mounted on the accelerator pedal arm such that a face of the accelerator pedal forms a first angle with respect to a floor structure of the vehicle and the brake pedal is mounted on the brake pedal arm such that a face of the brake pedal forms a second angle with respect to the floor structure. The first and second angles are predetermined to ergonomically orient the accelerator and brake pedals to generally match or compliment a typical foot angle of a driver when comfortably operating the pedals.

In various embodiments, the modular A&B assembly further includes an undercarriage pan that covers underside of the modular A&B assembly to protect the modular A&B assembly from infiltration of and/or damage by ground liquids, objects and debris.

In various embodiments, the accelerator pedal subassembly includes an accelerator pedal position sensor coupled to the accelerator pedal shaft. The accelerator pedal position sensor outputs a propulsion control signal to a system controller to control acceleration and deceleration of the vehicle. The propulsion control signal output by the accelerator pedal position sensor is substantially proportional to an amount of rotation of the accelerator pedal shaft. The system controller commands the motor to impart torque forces that affect movement of the vehicle in accordance with the propulsion control signal. A throttle enable switch of the accelerator pedal subassembly, e.g. a normally open switch, is adapted to control transmission of the propulsion control signal.

The brake pedal subassembly includes a brake pedal position sensor coupled to the brake pedal shaft. The brake pedal position sensor outputs a braking control signal to the system controller to control braking of the vehicle. The braking control signal output by the brake pedal position sensor is substantially proportional to an amount of rotation of the brake pedal shaft. Based on the braking control signal, the system controller induces a regenerative braking torque on the motor that is substantially proportional to the amount of rotation of the brake pedal shaft. A full stroke switch of the brake pedal subassembly, e.g. a normally closed switch, is adapted to actuate an electronically controlled friction brake mechanism of the braking assembly when the brake pedal is depressed to a position that is within a specified percentage of a maximum brake pedal stroke. The brake pedal subassembly additionally includes an active force feedback device adapted to bias the brake pedal toward a non-depressed position and provide a progressive resistive force during depression of the brake pedal. Therefore, the active force feedback device provides or exerts a brake pedal resistance or ‘feel’ to the driver of the vehicle that simulates the resistance or ‘feel’ generated by known mechanical friction brake mechanisms.

In various embodiments, the brake pedal subassembly further includes a parking brake subassembly that includes a pair of ratchet tooth pawls affixed to an inner side of each of the brake mounts, each of the pawls comprising a plurality of ratchet teeth. The parking brake subassembly additionally includes a latch pin extending through opposing slots in opposing sides of a U-channel brake pedal arm extending between the ratchet tooth pawls. Furthermore, the parking brake subassembly includes a dual spring engagement mechanism slidably mounted within the U-channel brake arm. The latch pin extends through a collar of the dual spring engagement mechanism such that the dual spring engagement mechanism can move the latch pin within the opposing slots. A connecting rod of the parking brake subassembly has a first end retained within an upper end of the collar and a second end attached to a park brake pedal. Depression of the park brake pedal displaces the connecting rod causing the dual spring engagement mechanism to move the latch pin within the opposing slots and engage the ends of the latch pin with longitudinally aligned sets of teeth of the ratchet tooth pawls. The latch pin ends are frictionally retained within the teeth by rotational forces applied to the brake pedal shaft by brake cables connected to a mechanical friction brake mechanism. Thus, when the park brake pedal is depressed the mechanical friction brake mechanism is activated and maintained in an actuated position due the engagement of the latch pin ends with the teeth of the ratchet tooth pawls.

The collar of the dual spring engagement mechanism is slidably positioned within an aperture of a brake pedal arm upper cross-member that extends between the sides of the U-channel brake pedal arm. The dual spring engagement mechanism additionally includes a piston rod slidably positioned within an aperture of a brake pedal arm lower cross-member that extends between the sides of the U-channel brake pedal arm. A lower end of the piston rod is in contact with a disengaging cam rotatably mounted on the brake pedal shaft and an upper end of the piston rod is retained within a lower end of the collar. A lower biasing device is positioned around the upper end of the piston rod and retained between the lower cross-member and the lower end of the collar. The lower biasing device applies a uniform force to disengage the latch pin ends from the teeth of the ratchet tooth pawls when the brake arm is moved by depressing the brake pedal. An upper biasing device is positioned within the upper end of the collar and retained between the latch pin extending through the collar and the first end of the connecting rod. The upper biasing device applies a uniform force to the latch pin as the park brake pedal is depressed to engage the ends of the latch pin with the ratchet tooth pawls.

Additionally, the modular A&B assembly includes a bell crank pivotally mounted to the underside of the mounting plate. The bell crank is connected at a first end, via a first tie rod, to the disengaging cam rotatably mounted on the brake pedal shaft. A second end of the bell crank is connected, via a second tie rod, to a ball stud coupled to the accelerator pedal shaft. Therefore, rotation of the accelerator pedal shaft causes the bell crank to rotate the disengaging cam about the brake pedal shaft, whereby the disengaging cam moves the piston rod causing the collar to disengage the latch pin from the ratchet tooth pawls.

In various embodiments, the brake pedal subassembly further includes a pressure sensitive brake light switch within a brake pedal pad coupled to a metallic brake pedal. The switch includes a wire molded into the brake pedal pad such that when the brake pedal pad is depressed an exposed portion of the wire contacts the metallic brake pedal, thereby completing a brake light circuit and illuminating a brake light of the vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a utility vehicle including a motive control system, in accordance with various embodiments of the present invention;

FIG. 2 is a bottom isometric view of a modular accelerator and brake (A&B) assembly included in the motive control system, shown in FIG. 1;

FIG. 3 is an isometric illustration of modular A&B assembly mounted to a frame structure of a utility vehicle;

FIG. 4 is a bottom view of the modular A&B assembly shown mounted to the frame structure;

FIG. 5 is sectional front view of a portion of the motive control system in accordance with various embodiments of the present invention;

FIG. 6 is an isometric side view of a protective undercarriage pan of the motive control system in accordance with various embodiments of the present invention;

FIG. 7 is an isometric view of a floor structure of a utility vehicle including a protective undercarriage pan in accordance with various other embodiments of the present invention;

FIG. 8 is an isometric view of an A&B assembly for use in a substantially electronic modular A&B assembly according to various embodiments of the present invention;

FIG. 9 is a bottom view of the electronic modular A&B assembly shown in FIG. 8;

FIG. 10 is a front view of the electronic modular A&B assembly shown in FIG. 8;

FIG. 11 is a bottom view of a modular A&B assembly for use in a substantially mechanical modular A&B assembly according to various embodiments of the present invention;

FIG. 12 is a front view of a portion of a brake pedal subassembly of the mechanical modular A&B assembly shown in FIG. 11;

FIG. 13 is an isometric view of the portion of the brake pedal subassembly shown in FIG. 12;

FIG. 14 is an isometric view of a brake pedal portion of the brake pedal subassembly shown in FIG. 12;

FIG. 15 is a side view of a portion of the utility vehicle shown in FIG. 1 for illustrating an ergonomic positioning and orientation of accelerator and brake pedals of the modular A&B assembly; and

FIG. 16 is a top view of the portion of the utility vehicle illustrated in FIG. 15, for further illustrating the ergonomic positioning and orientation of the accelerator and brake pedals.

### DETAILED DESCRIPTION OF THE INVENTION

The following description of the various embodiments is merely exemplary in nature and is in no way intended to limit the invention, its application, or uses.

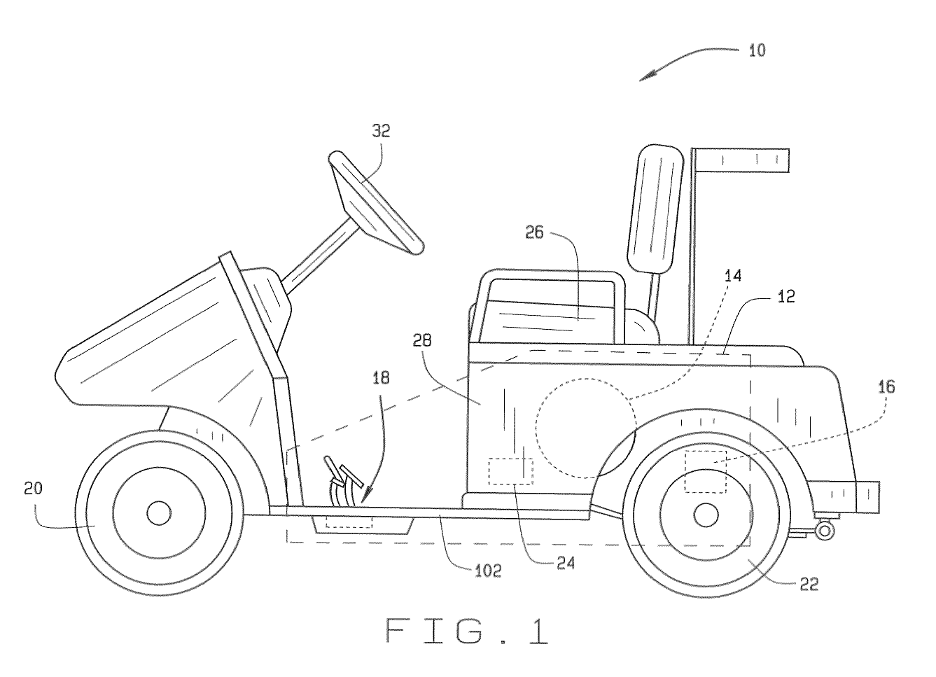

FIG. 1 depicts a light-weight utility vehicle 10, such as a golf car, having a motive control system 12 in accordance with the various embodiments. In various embodiments, the motive control system 12 includes a primary mover 14 adapted to deliver torque to affect movement of the vehicle 10 and a braking assembly 16 adapted to apply frictional forces to impede movement of the vehicle 10. The motive control system 12 additionally includes a modular accelerator and brake (A&B) assembly 18 that enables a driver to control acceleration and braking of vehicle 10, as described in detail below. In various embodiments, the vehicle 10 additionally includes a pair of front wheels 20, a pair of rear wheels 22, and a drive train controller 24. Generally, the front wheels 20 operate to steer the vehicle 10, at least one of the rear wheels 22 functions as a drive wheel for propelling vehicle 10, and the drive train controller 24 controls transferring torque from the prime mover 14, as a non-limiting example an internal combustion engine or electric motor, to the drive wheel. The vehicle 10 further includes a driver's seat 26 to accommodate a driver and a passenger's seat (not shown) that accommodates a passenger. The driver's seat 26 and passenger's seat can be combined to form a single bench type seat mounted to a seat base 28 of the vehicle 10. Alternatively, the driver's seat 26 and the passenger's seat can be independent seats mounted side-by-side on the seat base 28. The vehicle 10 also includes a steering wheel 32 which controls a steering angle of the front wheels 20.

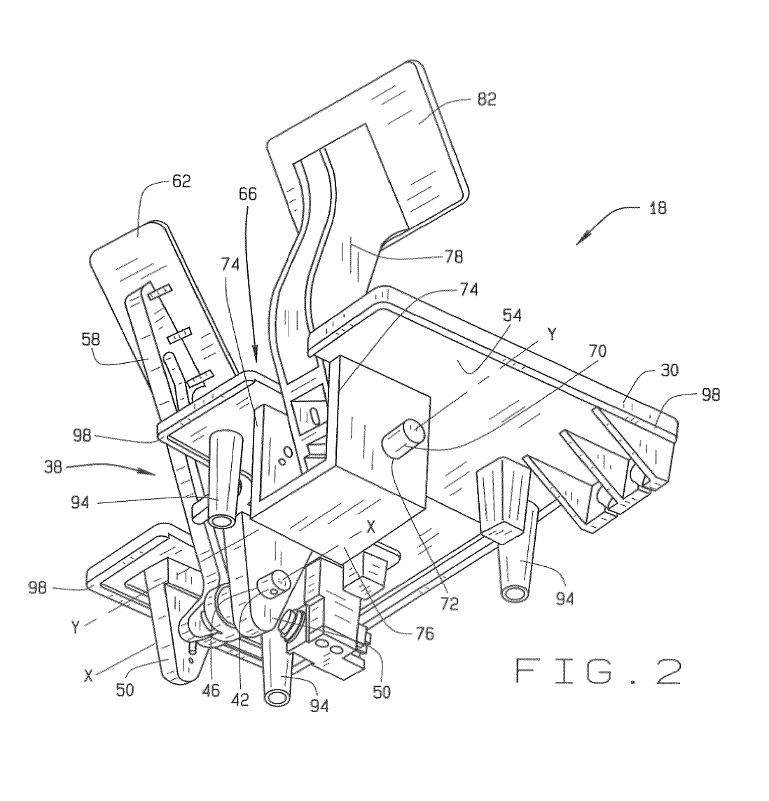

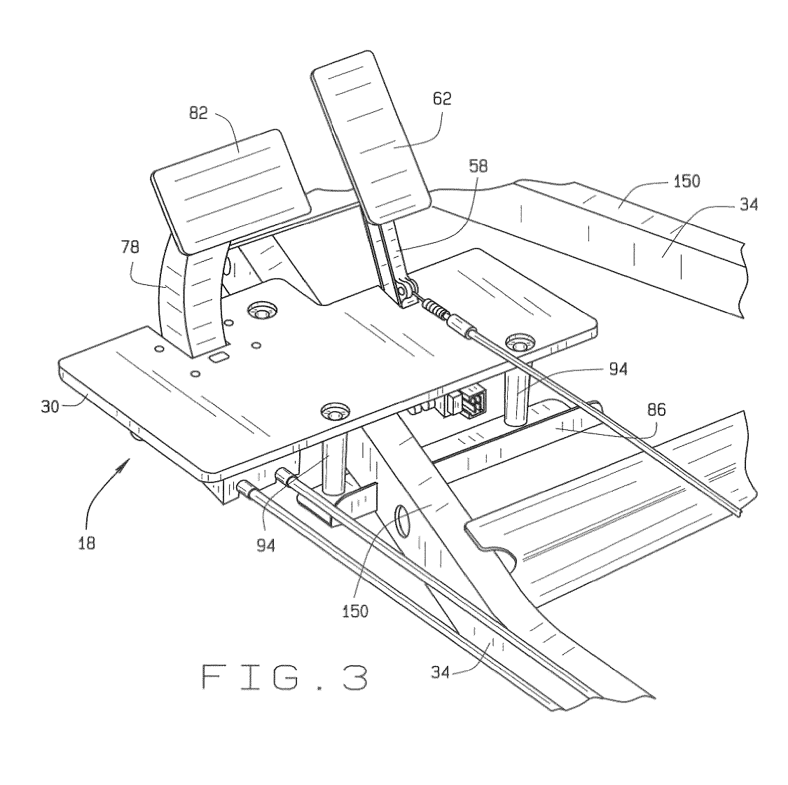

FIG. 2 is an isometric illustration of the modular A&B assembly, in accordance with various embodiments of the present invention. The modular A&B assembly 18 generates electrical and/or mechanical control signals utilized to control the operation of the primary mover 14 and the braking assembly 16. The modular A&B assembly 18 includes a mounting plate 30 connected to a frame structure 34 (shown in FIG. 3) of the vehicle 10. The modular A&B assembly 18 additionally includes an accelerator pedal subassembly 38 that includes an accelerator pedal shaft 42 rotatably mounted within a pair of opposing apertures 46 (only one aperture 46 is visible in FIG. 2) in a pair of accelerator mounts 50 extending from an underside 54 of the mounting plate 30.

An accelerator pedal arm 58 is fixedly coupled to the accelerator pedal shaft 42 such that when the accelerator pedal arm 58 is moved, the accelerator pedal shaft 42 rotates within the apertures 46. In some embodiments, the accelerator pedal arm 58 can be coupled to the accelerator shaft 42 using one or more set screws, roll pins, or nut and bolt fasteners. An accelerator pedal 62 is coupled to the accelerator pedal arm 58 via any suitable coupling means, including, by way of non-limiting example, rivets, screws, nuts and bolts or welding. Alternatively, the accelerator pedal arm 58 and pedal 62 could be a one piece plastic or cast aluminum component.

The modular A&B assembly 18 further includes a brake pedal subassembly 66 that includes a brake pedal shaft 70 rotatably mounted within a pair of opposing apertures 72 (only one aperture 72 is visible in FIG. 2) in a pair of brake mounts 74 extending from the underside 54 of the mounting plate 30. In various embodiments, the brake mounts 74 are opposing legs of a U-channel housing 76, as illustrated in FIG. 2. A brake pedal arm 78 is fixedly coupled to the brake pedal shaft 70 such that when the brake pedal arm 78 is moved, the brake pedal shaft 70 rotates within the apertures 72. For example, the brake pedal arm 78 can be coupled to the brake shaft 70 using one or more set screws, roll pins, or nut and bolt fasteners. A brake pedal 82 is coupled to the brake pedal arm 78 via any suitable coupling means, for non-limiting example, rivets, screws, nuts and bolts, or welding. Alternatively, the brake pedal arm 78 and pedal 82 could be a one piece plastic or cast aluminum component. The accelerator shaft 42 is adapted to rotate about an axis X while the brake pedal shaft 70 is adapted to rotate about an axis Y.

The accelerator mounts 50 and the brake mounts 74 locate the respective accelerator and brake shafts 42 and 70 in an off-set fashion such that the accelerator shaft axis X has a non-coaxial, non-collinear, and off-set orientation with respect to the brake shaft axis Y. The off-set or non-collinear axes X and Y allow the accelerator and brake pedals 62 and 82 to be positioned ergonomically with respect to a driver of the vehicle 10, as described further below.

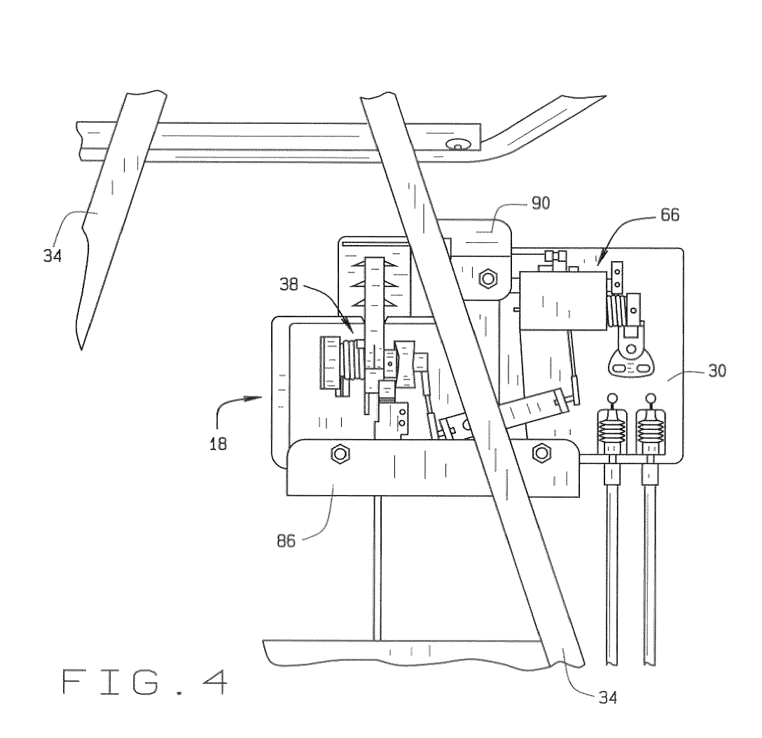

Referring now to FIGS. 3 and 4, attachment of the modular A&B assembly 18 will be described according to various embodiments. A first frame structure flange 86 and a second frame structure flange 90 are coupled, such as by welding or threaded fasteners, or the like, to the frame structure 34. Mounting plate 30 includes a plurality of stand-off towers 94 that hold the mounting plate 30 a specified distance above the first and second frame structure flanges 86 and 90. The mounting plate 30 couples to flanges 86 and 90 of the frame structure 34 by inserting threaded or other fasteners through stand-off towers 94 and using nuts to fasten the mounting plate 30 securely to the frame structure 34. Mounting plate 30, and therefore the modular A&B assembly 18, mounts to the frame structure 34 such that the modular A&B assembly 18 straddles a generally longitudinal member of the frame structure 34. More specifically, the mounting plate 30 is mounted to the frame structure flanges 86 and 90 such that the frame structure 34 runs between the accelerator pedal and brake pedal subassemblies 38 and 66. When the modular A&B assembly 18 is mounted to the frame structure 34, the accelerator pedal subassembly 38 is located on a first, interior, side of the frame structure 34, while the brake pedal subassembly 66 is located on an opposing second, exterior, side of the frame structure 34.

Referring to FIGS. 1, 2 and 5, in various embodiments, the mounting plate 30 includes a lip 98 formed around a perimeter of the mounting plate 30. The vehicle 10 includes a floor structure 102 that is mounted to the frame structure 34 and includes an opening 106 into which the modular A&B assembly is inserted. A perimeter of the floor structure opening 106 includes a recess 110 into which the lip 98 of the mounting plate 30 fits or mates to form a seal or barrier. The seal or barrier substantially prevents liquids, objects and debris from penetrating the joint between the lip 98 and recess 110 and causing damage to, interference with or corrosion of, the accelerator and brake subassemblies 38 and 66. A mounting plate cover 114 is positioned over an upper surface 118 of the mounting plate 30. In various embodiments, a floor mat 122 is placed over the mounting plate cover 114 and the floor structure 102. The mounting plate cover 114 is adapted to provide a substantially smooth continuation of an upper surface 126 of the floor structure across the modular A&B assembly 18. The mounting plate cover 114 additionally adds a barrier to liquids, objects and debris from infiltrating the recess 110, and therefore, adds an extra or second barrier to liquids, objects and debris penetrating the joint between the lip 98 and recess 110.

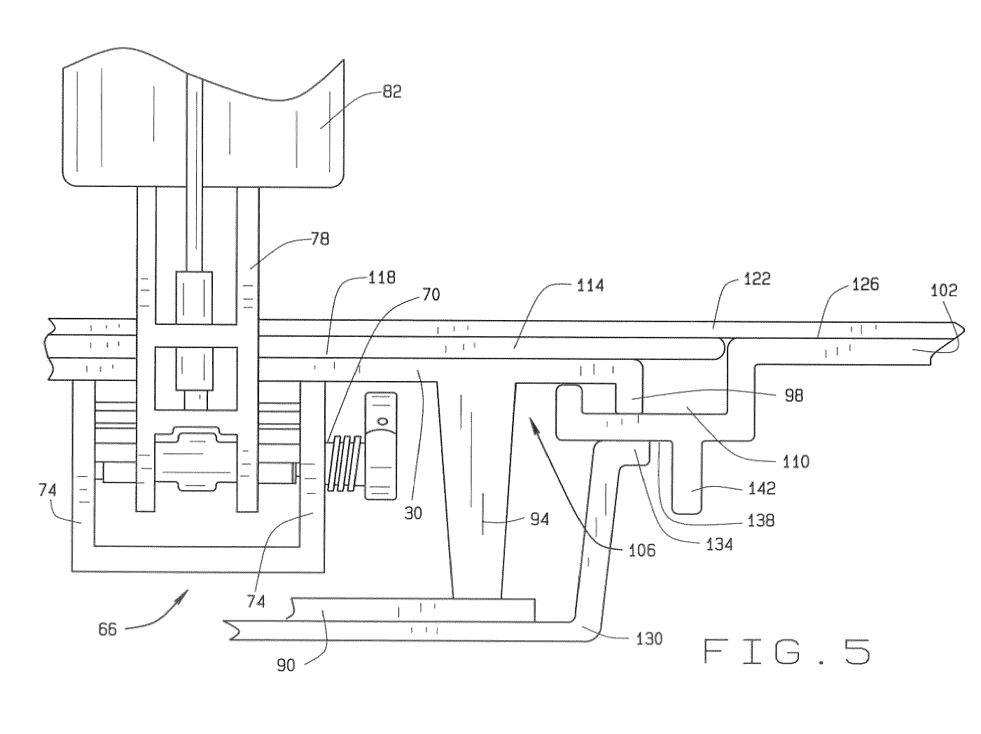

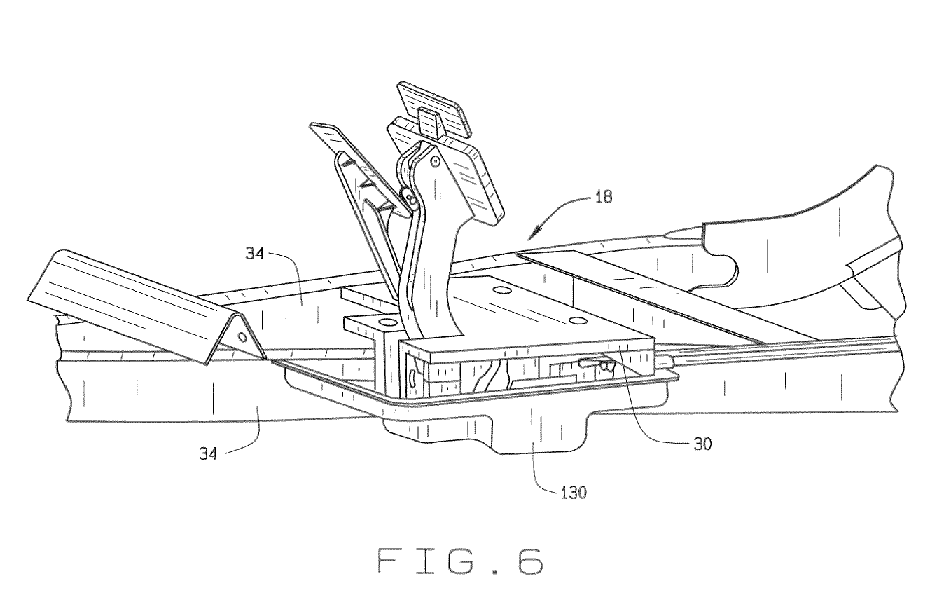

Referring now to FIGS. 5 and 6, in some embodiments the motive control system 12 includes an undercarriage pan 130 that covers the underside of the modular A&B assembly 18 and a portion of the frame structure 34 including the flanges 86 and 90. The undercarriage pan 130 is coupled to the frame structure flanges 86 and 90 and includes a lip 134 that fits against an underside 138 of the recess 110 in the floor structure 102 to form a barrier or seal against ground liquids, objects, and debris from infiltrating the accelerator and brake subassemblies 38 and 66. Additionally, the undercarriage pan 130 covers the underside of the modular A&B assembly 18, thereby providing a protective shield against ground liquids, objects, and debris from causing damage to, interference with or corrosion of, the accelerator and brake subassemblies 38 and 66.

In some embodiments, the floor structure 102 includes a splash shield 142 extending from the underside 138 of the recess 110 just adjacent to and around a perimeter of the lip 134. The splash shield 142 provides an additional barrier to ground liquids, objects, and debris from penetrating the joint or seal formed between the lip 134 of the undercarriage pan 130 and the underside 138 of the recess 110, thereby providing yet another barrier against ground liquids, objects, and debris from causing damage to, interference with or corrosion of, the accelerator and brake subassemblies 38 and 66.

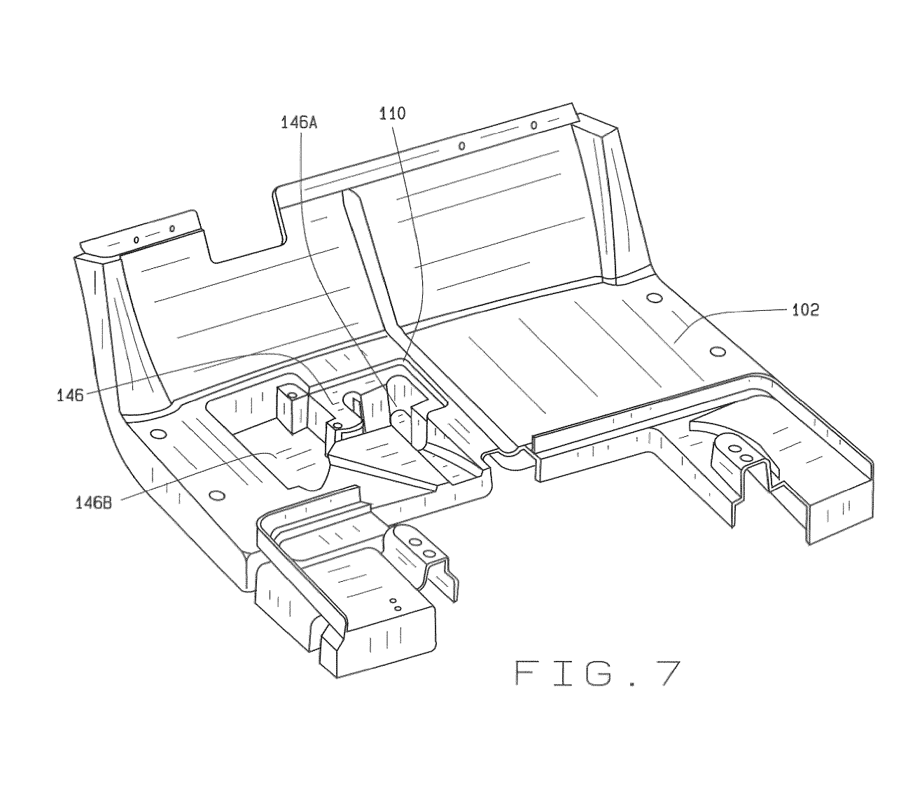

Referring now to FIG. 7, in various embodiments the motive control system 12 includes an undercarriage pan 146 formed in the floor structure 102. More particularly, the undercarriage pan 146 comprises a cavity formed in the floor structure 102 into which the modular A&B assembly 18 is placed. The perimeter or cavity of the undercarriage pan 146, includes the recess 110 into which the mounting plate lip 98 fits, as shown in FIG. 5. The floor structure 102 is placed over and connected to a top surface 150 (shown in FIG. 3) of the frame structure 34 and flanges 86 and 90. Therefore, the modular A&B assembly 18 is mounted to the frame structure flange 86 and 90 via threaded or other fasteners, as described above, that extend through a bottom of the undercarriage pan 146 and then through the flanges 86 and 90. Additionally, the undercarriage pan 146 is formed to allow the frame structure 34 to intersect the cavity such that the cavity is divided into an accelerator subassembly sub-cavity 146A and a brake subassembly sub-cavity 146B. Thus, when the modular A&B assembly 18 is placed within the undercarriage pan 146 and mounted to the frame structure flanges 86 and 90, the accelerator subassembly 38 is located on the first or interior side of the frame structure 34 while the brake pedal subassembly 66 is located on the opposing second or exterior side of the frame structure 34. The undercarriage pan 146 covers the underside of the modular A&B assembly 18 to thereby provide a protective shield against ground liquids, objects, and debris from causing damage to, interference with or corrosion of the accelerator and brake subassemblies 38 and 66.

Electronic A&B Assembly

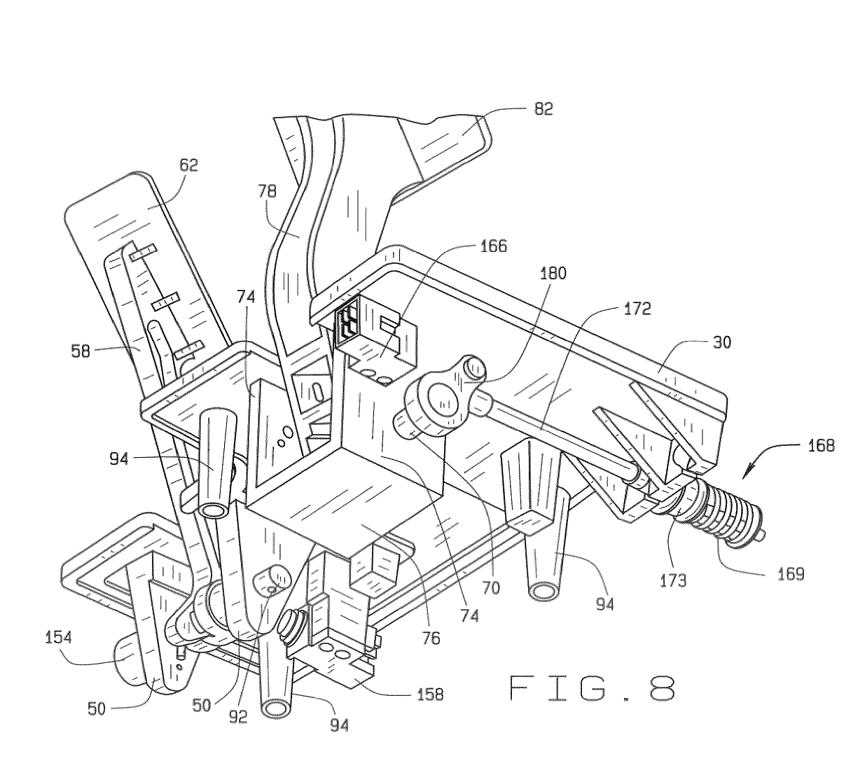

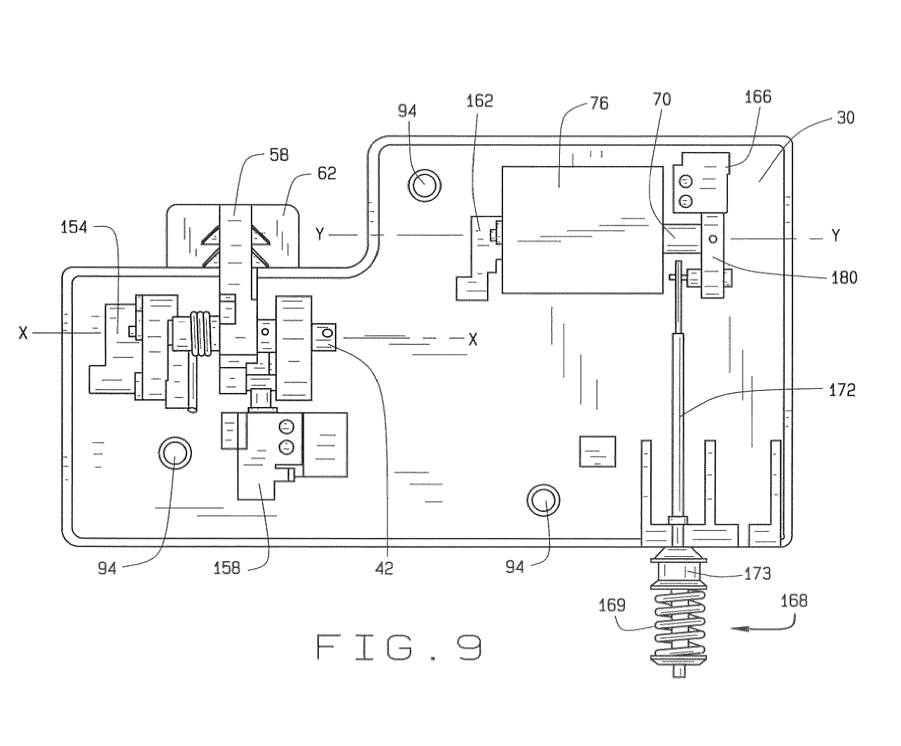

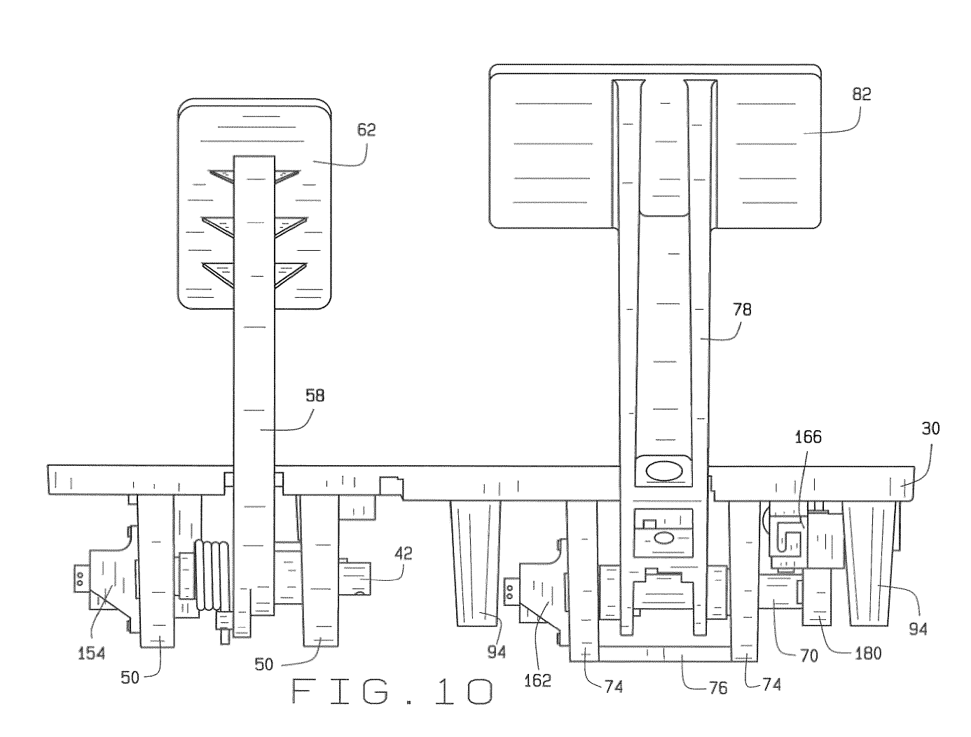

FIGS. 8, 9 and 10 illustrate an various embodiments of the modular A&B assembly 18 in which the modular A&B assembly is generally implemented in an electronic modular A&B assembly. The accelerator pedal subassembly 38 includes an accelerator pedal position sensor 154 coupled to one of the accelerator mounts 50 and cooperative or interactive with the accelerator pedal shaft 42. The accelerator pedal position sensor 154 is adapted to output a requested speed control signal proportional to a position of the accelerator pedal shaft 42 for controlling the speed of the vehicle 10. In various embodiments, the accelerator pedal position sensor is implemented as an angular position sensor. The accelerator pedal subassembly 38 additionally includes a normally open throttle enable switch 158 mounted to the underside of the mounting plate 30. The throttle enable switch 158 is adapted to enable or disable orientation of the vehicle 12. More particularly, when the throttle enable switch 158 is in an “open” state, indicating that the accelerator pedal arm 58 is in a “full-up” or non-depressed position, operation of the prime mover 14 is disabled and, consequently the accelerator pedal position sensor 154 is effectively disabled. When throttle enable switch 158 is open for a predetermined time, drive train controller 24 may actuate the braking assembly 16, as described below. Conversely, when the throttle enable switch 158 is in a “closed” state indicating the accelerator pedal arm 58 has been depressed or moved toward a front of the vehicle 10, operation of the prime mover 14 is enabled and, and consequently the accelerator pedal position sensor 154 is effectively enabled.

The brake pedal subassembly 66 includes a brake pedal position sensor 162 coupled to one of the brake mounts 74 and cooperative or interactive with the brake pedal shaft 70. The brake pedal position sensor 162 is adapted to output a requested braking control signal utilized to reduce the speed and control deceleration of the vehicle 10. The rate of speed reduction is proportional to the amount of rotation of the brake pedal shaft 70. In some embodiments, the brake pedal position sensor 162 is implemented as an annular position sensor. The brake pedal subassembly 66 additionally includes a normally closed full stroke switch 166 coupled to the underside of the mounting plate 30. The full stroke switch 166 is adapted to actuate an electronically controlled friction brake mechanism of the braking assembly 16 when the brake pedal 82 is depressed to a position that is within a specified percentage of a maximum brake pedal stroke. This provides an emergency brake function. In various embodiments, the braking assembly 16 is an electrically controlled braking system (ECBS) that electronically maintains the electronically controlled friction brake mechanism in a released or unapplied, position until commanded to operate the electronically controlled friction brake mechanism to slow or inhibit movement of the vehicle 10. More specifically, an electrical circuit operates an electrical braking component, such as a solenoid. The electrical braking component holds the brake pads, shoes or the like of the electronically controlled friction brake mechanism away from an associated shaft, drum, or disk until the electrical braking component is commanded to enable contact between the brake pads, shoes or the like and the associated shaft, drum, or disk. Such an ECBS is described in copending provisional patent application Ser. No. 60/623,149, filed Oct. 28, 2004, titled AC Drive System For Electrically Operated Vehicle, and assigned to the assignee of the present invention, which is incorporated herein by reference.

In some embodiments, during driving modes when the brake pedal 82 is not depressed, the electrical braking component is powered by the drive train controller 24 to maintain the electronically controlled friction brake mechanism in the released or unapplied position. The brake pedal position sensor 162 outputs a sensor signal in accordance with the position of brake pedal 82. The required amount of regenerative braking and electrical energy applied to the electrical braking component varies in accordance with the amount of depression of the brake pedal 82. Thus, the brake pedal position sensor 162 is used for service braking by commanding a given motor speed reduction per unit time. The position of brake pedal 82, as sensed by pedal position sensor 162, provides an input to the drive train controller 24 to determine the amount of regenerative braking, and, when appropriate, a degree of actuation or deployment of the electronically controlled friction brake mechanism to achieve a desired braking condition. More particularly, the brake pedal position sensor 162 outputs a brake pedal position signal input to the drive train controller 24. The drive train controller 24 outputs a signal to reduce the motor speed and induce a deceleration proportional to the pedal position.

In some embodiments, when the brake pedal 82 is depressed to within a predetermined amount, such as about 5%, of a maximum brake pedal stroke to activate full stroke switch 166, power to the electrical braking component is interrupted so that the electrical braking component applies a resisting force to the force output by primary mover 14. This reduces the speed of primary mover 14 toward zero until the vehicle reaches zero speed or until brake pedal 82 is released to deactivate full stroke switch 166. More specifically, the electronically controlled friction brake mechanism is actuated or deployed by a biasing device (not shown), such as a spring, after approximately one second of interrupted power. Deployment of the biasing device applies the brake pads, shoes or the like to the shaft, drum, or disk. In some embodiments, the biasing device of the electronically controlled friction brake mechanism is sized to apply a braking torque equal to or greater than about 120% of the primary mover 14 maximum dynamic torque. As stated above, the electronically controlled friction brake mechanism will remain applied until the brake full stroke switch 166 is deactivated. For example, the full stroke switch 166 will be deactivated when approximately five volts or greater is applied to the full stroke switch 166 by depression of the accelerator pedal 62.

In various embodiments, the brake pedal subassembly 66 includes an active force feedback device 168 adapted to bias the brake pedal 82 to a non-depressed position and provide a progressive resistive force during depression of the brake pedal 82. The active force feedback device 168 includes a biasing device 169, for non-limiting example a spring, connected to a transfer rod 172 that is also connected to a crank 180 fixedly coupled to the brake shaft 70. As the brake pedal shaft 70 rotates via depression of the brake pedal 82, the crank 180 rotates, moving the transfer rod 172 and compressing the biasing device 169. The further the brake pedal 82 is depressed, the further the biasing device 169 is compressed, thereby progressively increasing an amount of resistive force to depression of the brake pedal 82. Thus, the active force feedback device 168 provides or exerts a brake pedal resistance or ‘feel’ to the driver of the vehicle that simulates the resistance or ‘feel’ generated by known mechanical friction brake mechanisms. The force feedback device 168 additionally includes an annular compliant bushing or washer 173 about the transfer rod 172 and captured between the biasing device 169 and mounting plate 30. When the brake pedal 82 is depressed to approximately the “full stroke” position the biasing device 169 will be effectively completely compressed. Further depression of the brake pedal causes the biasing device to compress the busing 173. The bushing 173 is fabricated from a rubber-like material having a modulus of elasticity sufficient to provide substantial resistance to the further depression of the brake pedal 82. Therefore, the bushing 173 provides a cushioned stop that simulates the resistance or “feel” generated by known mechanical friction brake mechanisms when the brake pedal of such know mechanisms is depressed to the “full stroke” position.

Mechanical A&B Assembly

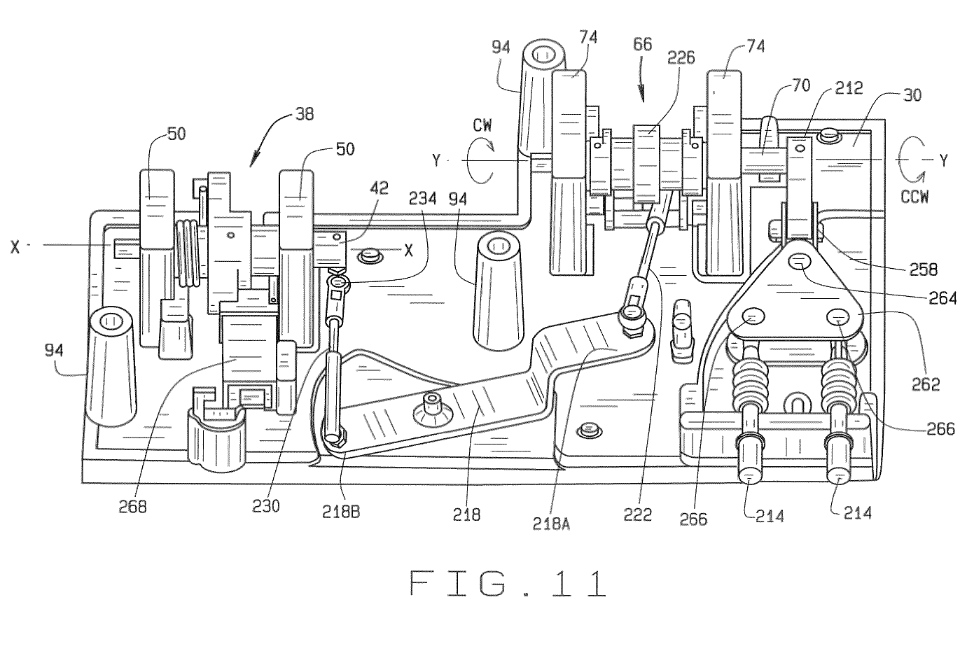

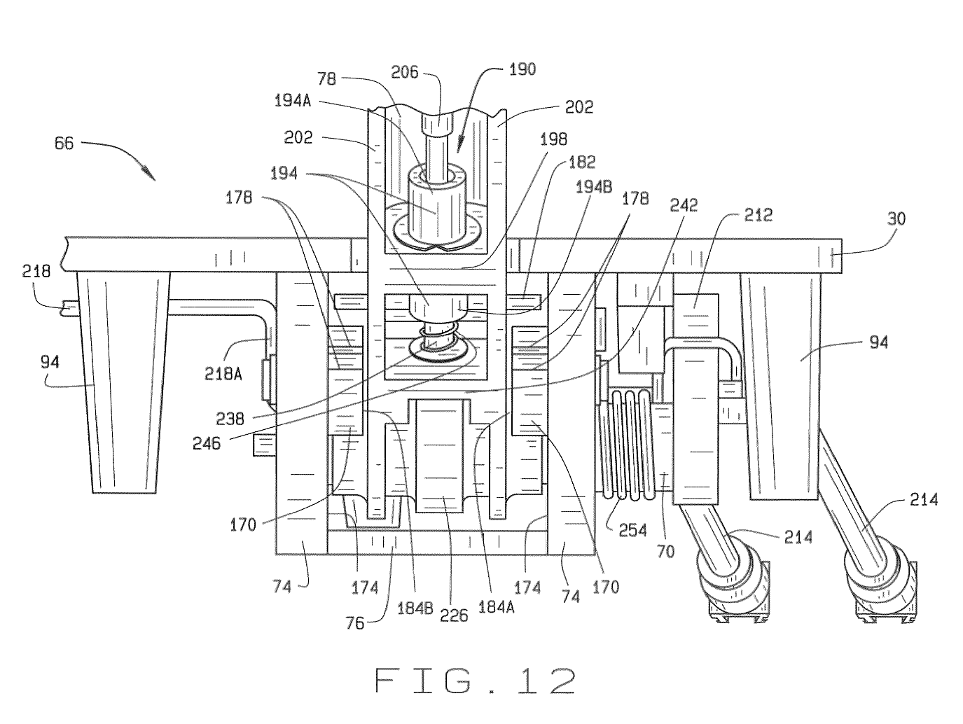

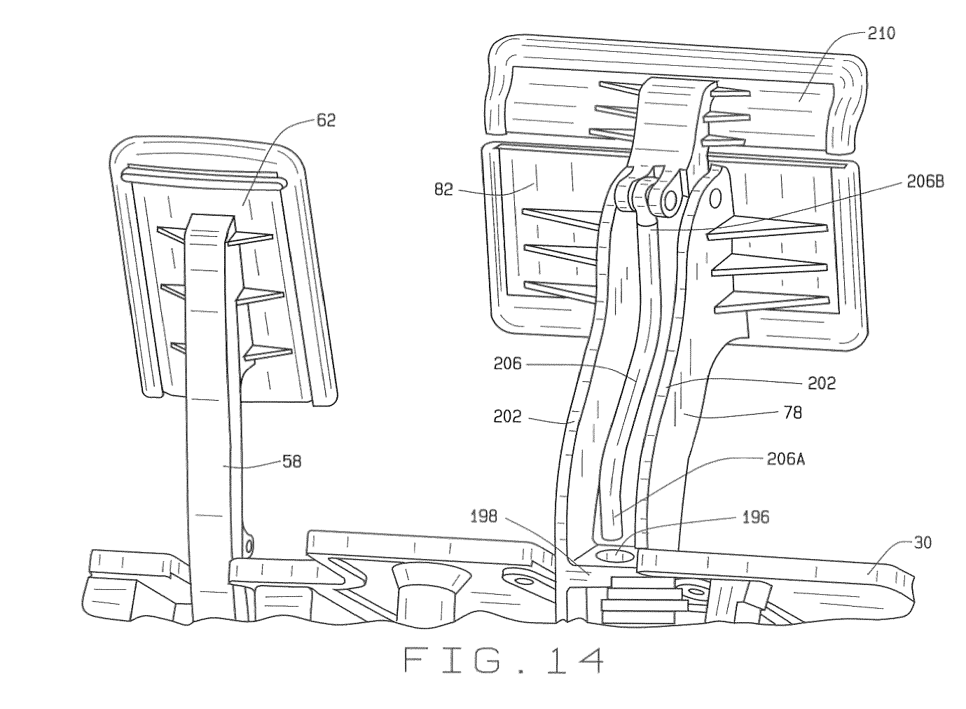

FIGS. 11, 12, 13 and 14 illustrate various embodiments of the present invention in which the modular A&B assembly 18 is configured to operate a utility vehicle 10 powered by an internal combustion engine. As described herein, the modular A&B assembly 18 controls an internal combustion drive system and mechanical braking system as may conventionally appear on a utility vehicle. The brake pedal subassembly 66 includes a pair of ratchet tooth pawls 170, each of the ratchet tooth pawls 170 affixed to an inner side 174 of one of the brake mounts 74. Each of the ratchet tooth pawls 170 includes a plurality of ratchet teeth 178. The ratchet tooth pawls 170 are affixed to the inner sides 174 of the brake mounts 74 using suitable fasteners that will securely affix the pawls 170 such that they will not move, rotate or change position. For non-limiting example, the ratchet tooth pawls 170 can be affixed to the inner sides 174 using roll pins 171 and screws or spiral pins and screws. Additionally, the pawls 170 are affixed to the brake mounts 74 such that the teeth 178 of one pawl 170 substantially longitudinally align with the teeth 178 of the other pawl 170. The brake pedal subassembly 66 includes a latch pin 182 that extends through opposing slots 186 in opposing sides of a U-channel shaped brake pedal arm 78. The U-channel brake arm 78 is coupled to the brake pedal shaft 70 and extends between the ratchet tooth pawls 170 such that slight gaps 184A and 184B exist between the brake arm 78 and the ratchet tooth pawls 170. For non-limiting example, the gaps 184A and 184B can be between approximately 1.0 and 3.0 millimeters. Thus, there is no friction or interference between the brake arm 78 and the pawls 170 to impede the rotational movement of the brake arm 78 about the brake shaft axis Y.

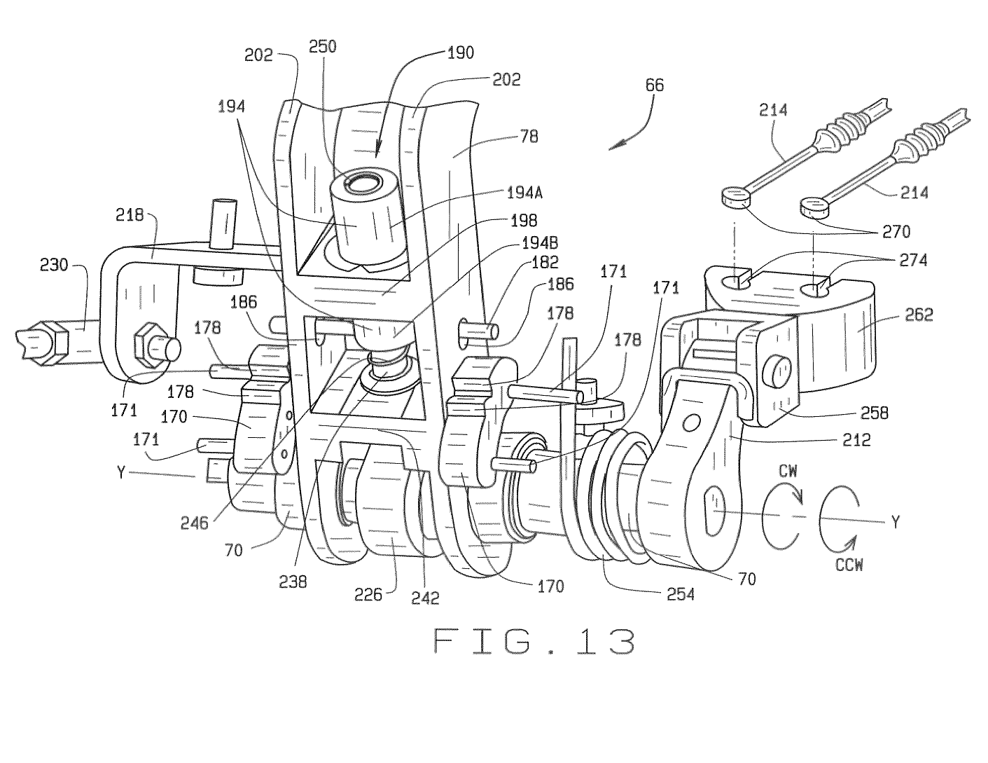

A dual spring engagement mechanism 190 is slidably mounted within an upper cross-member 198 of the U-channel brake pedal arm 78. The latch pin 182 extends through a collar 194 of the dual spring engagement mechanism 190 that is slidably positioned within an aperture 196 of the brake pedal arm upper cross-member 198 extending between sides 202 of the U-channel brake pedal arm 78. The latch pin 182 extends through the collar 194 so that the dual spring engagement mechanism 190 will move the latch pin 182 within the opposing slots 186. A connecting rod 206 has a first end 206A retained within an upper end 194A of the collar 194 and a second end 206B pivotally attached to a park brake pedal 210. Depression of the park brake pedal 210 displaces the connecting rod 206 causing the dual spring engagement mechanism 190 to move the latch pin 182 downward within the opposing slots 186. Additionally, depression of the park brake pedal 210 rotates the brake arm 78 and the brake pedal shaft 70 about the Y axis in a first direction CCW, as shown in FIG. 13.

Rotating the brake pedal shaft 70 in the CCW direction causes a crank 212 fixedly connected to the brake pedal shaft 70 to also rotate about the Y axis in the CCW direction. Rotation of the crank 212 in the CCW direction applies tension to a pair of brake cables 214 that are connected at one end to the crank 212, as described below, and connected at opposing ends to a mechanical friction brake mechanism (not shown) of the braking assembly 16. The mechanical friction brake mechanism can be any suitable mechanical friction brake mechanism, such as a drum/shoe, rotor/pad, or steel band/polished drum. Therefore, depression of the park brake pedal 210 deploys or actuates the mechanical friction brake mechanism to retard movement of the vehicle 10.

When the connecting rod 206 moves the latch pin 182 downward within the slots 186, the opposite ends of latch pin 182 engage longitudinally aligned sets of teeth 178 of the ratchet tooth pawls 170. When the ends of the latch pin 182 engage the teeth 178, the ends of the latch pin 182 are kept in place within the teeth 178 via force applied to the brake pedal shaft 70, in a second direction CW, by tension in brake cables 214 resulting from actuation of the mechanical friction brake mechanism. The ends of the latch pin 182 are retained within the teeth 178 of the pawls 170, and the mechanical friction brake mechanism is maintained in the applied or deployed position, typically to maintain the brake mechanism in a “parking brake” state. The brake will generally remain engaged, i.e., remain in the parking brake state, until the ends of the latch pin 182 are disengaged from the pawl teeth 178, as described below. Each ratchet tooth pawl 170 includes multiple teeth 178 to accommodate a wide range of applied braking forces required to maintain the vehicle 10 in the parked state, as a well as accommodating for wear of the brake pedal subassembly 66 and/or the mechanical friction brake mechanism.

The modular A&B assembly 18 further includes a bell crank 218 pivotally mounted to the underside of the mounting plate 30. The bell crank 218 is connected at a first end 218A via a first tie rod 222 to the disengaging cam 226 rotatably mounted on the brake pedal shaft 70. A second end 218B of the bell crank 218 is connected via a second tie rod 230 to a ball stud 234 coupled to the accelerator pedal shaft 42. The dual spring engagement mechanism 190 additionally includes a piston rod 238 slidably positioned within an aperture of a brake pedal arm lower cross-member 242 that extends between the sides of the U-channel brake pedal arm 78. A lower end of the piston rod 238 contacts the disengaging cam 226 and an upper end of the piston rod is retained within the lower end 194B of the collar 194. A lower biasing device 246, such as a spring, is positioned around the upper end of the piston rod 238 and is retained between the lower cross-member 242 and the lower end 194B of the collar 194. The lower biasing device 246 applies a uniform force to disengage the latch pin ends from the teeth 178 of the ratchet tooth pawls 170, i.e., release the braking mechanism from the parking brake state, when the brake arm 78 is moved by depressing the brake pedal 82, as described below. An upper biasing device 250, such as a spring, is positioned within the upper end 194A of the collar 194 and retained between the latch pin 182 extending through the collar 194 and the first end 206A of the connecting rod 206. The upper biasing device 250 applies a uniform force to the latch pin as the park brake pedal 210 is depressed to engage the ends of the latch pin 182 with the ratchet tooth pawls 170, as described above. The uniform force of the upper biasing device 250 allows the ends of the latch pin 182 to ride over the teeth 178 of the ratchet tooth pawls 170 with very little feedback at the park brake pedal 210. The operator of the park brake pedal 210 will feel a very smooth movement with minimal ratcheting, clicking or bumping when depressing of the park brake pedal 210.

Pressing the accelerator pedal automatically releases the parking brake. Rotating the accelerator pedal shaft 42 causes the second tie rod 230 to rotate the second end 218B of bell crank 218 about its pivot point. This causes first end 218A of the bell crank 218 to correspondingly rotate about the pivot point. The rotation of the bell crank 218 causes the first tie rod 222 to rotate the disengaging cam 226 about the brake pedal shaft 70. Rotation of the disengaging cam 226 pushes the piston rod 238 upward exerting an upward force on the collar 194 causing the collar 194 to disengage the latch pin 182 from the teeth 178 of the ratchet tooth pawls 170. In various embodiments, the lower and upper biasing devices 246 and 250 are adapted to provide substantially equal force on the collar 194 of the dual spring engagement mechanism 190 to enable dual spring engagement mechanism 190 to float within the aperture 196.

The latch pin 182 can also be disengaged from the ratchet tooth pawls 170 by depressing the brake pedal 82. Depression of the brake pedal 82 overcomes the frictional retention forces holding the ends of the latch pin 182 within the teeth 178 and moves the latch pin 182 slightly away from the teeth 178. Since the park brake pedal 210 is not being depressed, the connecting rod 206 is not pushing the latch pin 182 downward within the slots 186. Therefore, as the brake pedal 82 is depressed and the latch pin 182 is moved away from the teeth 178, the lower biasing device exerts a force on the collar 194 that moves the latch pin 182 upward within the slots 186 and the latch pin 182 ends sufficiently away from the ratchet tooth pawls 170. Once the latch pin 182 ends are moved away from the ratchet tooth pawls 170, the brake pedal 82 can be released and allowed to be returned to the upright or non-depressed position due to force exerted on the brake arm 78 by a brake return biasing device 254 positioned around the brake pedal shaft 70.

The brake pedal subassembly 66 further includes a clevis 258 pivotally connected to the crank 212 and an equalizer 262 pivotally connected to the clevis 258. The brake cables 214 are connected to the equalizer 262 such that when either the brake pedal 82 or the park brake pedal 210 are depressed, the crank 212 is rotated in the CCW direction, thereby deploying the mechanical friction brake mechanism, as described above. The equalizer 262 can be any suitable device for applying substantially equal tension to each of the brake cables 214 when either the park brake or brake pedals 210 and 82 are depressed. For example, the equalizer 262 can be a device that retains ends of the brakes cables 214 using pins 266, as shown in FIG. 11. Or, the equalizer 262 can be a device that retains barrels 270 affixed to the end of the brakes cables 214 within barrel retention slots 274 formed within the equalizer 262, as illustrated in FIG. 13. The equalizer 262 is pivotally connected to clevis 258 in any suitable manner such as by equalizer clevis pin 264, shown best in FIG. 11. When the crank 212 is rotated about the Y axis in the CCS direction the clevis 258 pulls the equalizer 262 generally in the direction of the front of the vehicle 10. If there is any discrepancy in the tension existing in the brake cables 214 as crank 212 starts to rotate in the CCW direction, the equalizer 262 will pivot about the equalizer clevis pin 264 to exert equal tension on each of the brake cables 214. Therefore, the equalizer 212 compensates for any inequity in the initial tension in the brake cables 214 such that as the brake pedal is depressed equal tension is applied to each of the brake cables 214.

The accelerator pedal includes a normally open and normally closed switch 268 used to detect depression of the accelerator pedal 62 to enable the prime mover 14 and disable operation of the prime mover 14 when the accelerator pedal 62 is released.

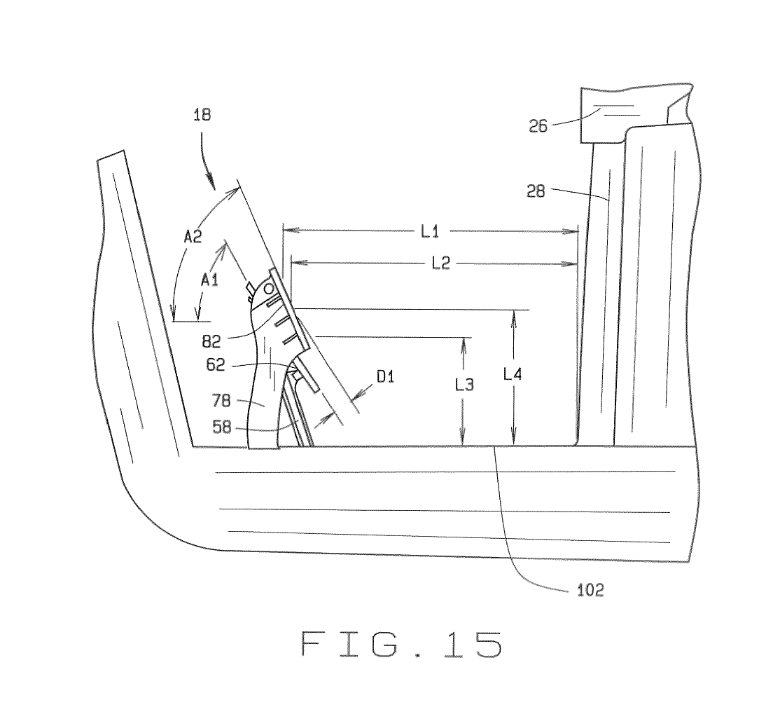

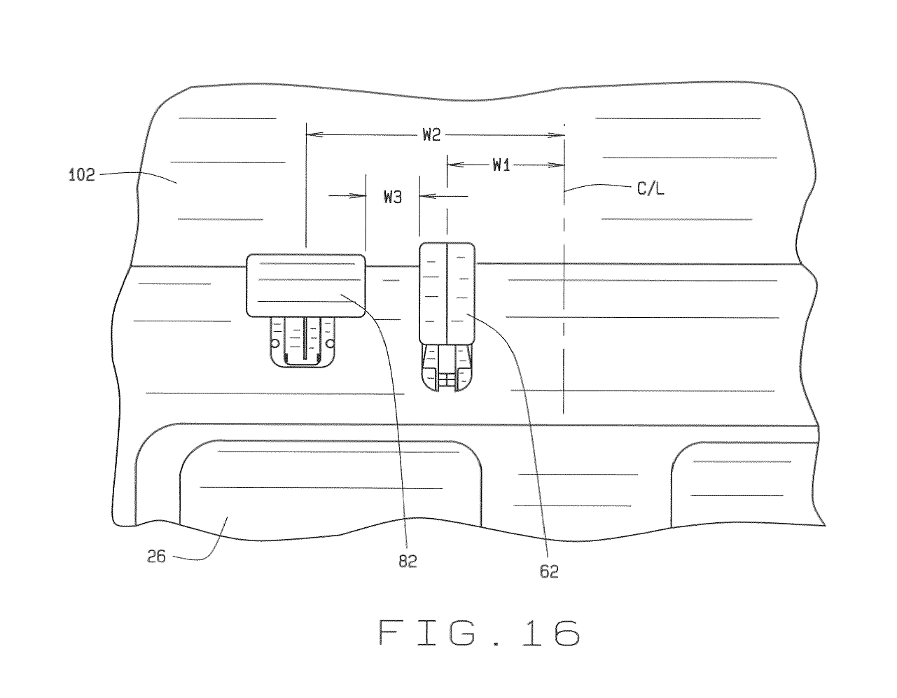

Referring now to FIGS. 15 and 16, the non-coaxial, non-collinear and off-set orientation of the accelerator pedal shaft 42 and the brake pedal shaft 70 provides an ergonomic location and orientation of the accelerator and brake pedals 62 and 82 for a driver sitting in the driver's seat 26. More specifically, the offset of the accelerator and brake axes X and Y locates the accelerator pedal 62 a first longitudinal distance L1 from the driver seat base 28 and the brake pedal 82 a second longitudinal distance L2 from the driver seat base L2 to thereby ergonomically locate the accelerator and brake pedals for the driver. For example, the L1 can be between approximately 13.50 and 14.50 inches, preferably approximately 14.00 inches, and L2 can be between approximately 13.25 and 14.25 inches, preferably approximately 13.75 inches.

Additionally, mounting the modular A&B assembly 18 so that it straddles the frame structure 34 further provides an ergonomic location and orientation of the accelerator and brake pedals 62 and 82 for a driver sitting in the driver's seat 26. More particularly, in various embodiments, mounting the modular A&B assembly 18 to straddle the frame structure 34 locates a center of the accelerator pedal 62 a first orthogonal distance W1 from a center line C/L of the vehicle floor structure 102. Additionally, a center of the brake pedal 82 is located a second orthogonal distance W2 from the center line C/L, thereby providing a distance W3 between the centers of the accelerator and brake pedals 62 and 82. Therefore, the accelerator and brake pedals 62 and 82 are ergonomically located for the driver sitting in a driver's seat 26. For example, W1 can be between approximately 3.50 and 5.50 inches, preferably approximately 4.43 inches, and W2 can be between approximately 10.50 and 13.00 inches, preferably approximately 11.87 inches and W3 can be between approximately 2.50 and 3.00 inches, preferably 2.75 inches.

Furthermore, in various embodiments, the accelerator pedal 62 is mounted on the accelerator pedal arm 58 such that a face of the accelerator pedal 62 forms a first angle A1 with respect to a substantially horizontal plane the floor structure 102. Additionally, the brake pedal 82 is mounted on the brake pedal arm 78 such that a face of the brake pedal 82 forms a second angle A2 with respect to the substantially horizontal plane of the floor structure 102. The first and second angles A1 and A2 further ergonomically orient the accelerator and brake pedals 62 and 82 for the driver. Additionally, an offset D1 between the surface of the accelerator pedal 62 and the surface of the brake pedal 82, still further ergonomically orient the accelerator and brake pedals 62 and 82 for the driver. For example, A1 can be between approximately 40.0° and 60.0°, such as approximately 50.0°, A2 can be between approximately 50.0° and 75.0°, such as approximately 61.0°, and D1 can be between approximately 0.5 and 1.5 inches, such as approximately 1.0 inches.

Further yet, in various embodiments, the accelerator pedal 62 is mounted on the accelerator pedal arm 58 such that the center of the accelerator pedal 62 is a first height L3 above a top surface of the floor structure 102. Additionally, the brake pedal 82 is mounted on the brake pedal arm 78 such that the center of the brake pedal 82 is a second height L4 above the top surface of the floor structure 102. The first and second heights L3 and L4 further ergonomically locate the accelerator and brake pedals 62 and 82 for the driver. For example, L3 can be between approximately 3.50 and 4.50 inches, preferably approximately 4.00 inches, and L4 can be between approximately 5.00 and 6.50 inches, preferably approximately 5.13 inches.

The description of the invention is merely exemplary in nature and, thus, variations that do not depart from the gist of the invention are intended to be within the scope of the invention. Such variations are not to be regarded as a departure from the spirit and scope of the invention.

What is claimed as new and desired to be protected by Letters Patent of the United States is:

1. A motive control system for a utility vehicle, said system comprising:
a modular accelerator and brake (A&B) assembly, said modular assembly including:
a mounting plate;
an accelerator pedal subassembly including an accelerator pedal and accelerator shaft rotationally mounted within a pair of opposing apertures within a pair of accelerator mounts extending from an underside of the mounting plate; and
a brake pedal subassembly including a brake pedal and a brake pedal shaft rotationally mounted within a pair of opposing apertures in a pair of brake mounts extending from the underside of the mounting plate, wherein an axis of the accelerator pedal shaft is offset from an axis of the brake pedal shaft.

2. The system of claim 1, wherein the mounting plate further includes a lip formed around a perimeter of the mounting plate, the lip adapted to fit within a recess formed in a floor structure of the utility vehicle.

3. The system of claim 2, wherein the system further includes a mounting plate cover adapted to be positioned over an upper surface of the mounting plate when the mounting plate lip is fitted within the floor structure recess.

4. The system of claim 1, wherein the system further includes an undercarriage pan that covers an underside of the modular A&B assembly.

5. The system of claim 4, wherein the undercarriage pan comprises a housing connected to a plurality of stand-offs extending from the underside of the mounting plate and including a lip that substantially forms a seal with an underside of a floor structure of the utility vehicle.

6. The system of claim 5, wherein the system further includes a splash shield extending from the underside of the floor structure around a perimeter of the housing lip.

7. The system of claim 4, wherein the undercarriage pan comprises a cavity formed within a floor structure of the utility vehicle into which the modular A&B assembly is placed.

8. The system of claim 1, wherein the modular A&B assembly is adapted to mount to a frame structure of the utility vehicle.

9. The system of claim 8, wherein the modular A&B assembly is further adapted to mount to the frame structure such that the accelerator subassembly is located on one side of the frame structure and the brake subassembly is located on an opposing side of the frame structure.

10. The system of claim 1, wherein the accelerator pedal subassembly includes an accelerator pedal position sensor interactive with the accelerator pedal to output an accelerator sensor signal in accordance with an amount of displacement of the accelerator pedal.

11. The system of claim 10, wherein the accelerator pedal subassembly further includes a throttle enable switch that generates a control signal used to enable and disable operation of the vehicle.

12. The system of claim 1, wherein the brake pedal subassembly includes a brake pedal position sensor interactive with the brake pedal to output a brake sensor signal in accordance with an amount of displacement of the brake pedal.

13. The system of claim 1, wherein the brake pedal subassembly includes a full stroke switch that generates a control signal to execute a parking brake operation when the brake pedal is depressed at least to a predetermined position.

14. The system of claim 1, wherein the brake pedal subassembly includes a bias device adapted to return the brake pedal to a non-depressed position.

15. The system of claim 1, wherein the brake pedal subassembly includes a bias device adapted to provide a progressively resistive force during depression of the brake pedal.

16. The system of claims 1, wherein the brake pedal subassembly includes a bushing adapted to provide a cushioned stop when the brake pedal is depressed to a full stroke position.

17. The system of claim 1, wherein the brake pedal subassembly includes:
a U-channel brake arm extending from the brake pedal and coupled to the brake pedal shaft; and
a crank coupled to the brake pedal shaft for exerting tension on brake cables when the brake pedal is displaced apply a mechanical friction brake mechanism.

18. The system of claim 17, wherein the brake pedal subassembly includes:
a pair of ratchet tooth pawls affixed to an inner side of each of the brake mounts, each of the pawls comprising a plurality of ratchet teeth;
a latch pin extending through opposing slots in opposing sides of the U-channel brake pedal arm that extends between the ratchet tooth pawls;
an engagement mechanism slidably mounted within the U-channel brake pedal arm and having the latch pin extending through the engagement mechanism such that the engagement mechanism is adapted to move the latch pin within the opposing slots; and
a connecting rod having a first end operatively connected to a first end of the engagement mechanism and a second end attached to a park brake pedal such that depression of the park brake pedal displaces the connecting rod causing the engagement mechanism to move the latch pin within the opposing slots and engage the ends of the latch pin with longitudinally aligned sets of teeth of the ratchet tooth pawls.

19. The system of claim 18, wherein the engagement mechanism includes:
a collar slidably positioned within an aperture of a brake pedal arm upper cross-member extending between the sides of the U-channel brake pedal arm;
a piston rod slidably positioned within an aperture of a brake pedal arm lower cross-member extending between the sides of the U-channel brake pedal arm, a lower end of the piston rod in contact with a disengaging cam rotatably mounted on the brake pedal shaft and an upper end of the piston rod retained within a lower end of the collar;
a lower biasing device positioned around the upper end of the piston rod and retained between the lower cross-member and the lower end of the collar, the lower biasing device adapted to disengage the latch pin ends from the teeth of the ratchet tooth pawls when the brake arm is moved by depressing the brake pedal mounted to the brake arm; and
an upper biasing device positioned within the upper end of the collar and retained between the latch pin extending through the collar and the first end of the connecting rod, the upper biasing device adapted to apply a uniform pressure to the latch pin as the park brake pedal is depressed to engage the ends of the latch pin with the ratchet tooth pawls.

20. The system of claim 19, wherein the modular A&B assembly further includes a bell crank pivotally mounted to the underside of the mounting plate, the bell crank connected at a first end to the disengaging cam via a first tie rod and connected, via a second tie rod, at a second end to a ball stud coupled to the accelerator pedal shaft such that rotation of accelerator pedal shaft causes the bell crank to rotate the disengaging cam about the brake pedal shaft, whereby the disengaging cam moves the piston rod causing the collar to disengage the latch pin from the ratchet tooth pawls.

21. The system of claim 20, wherein the brake pedal subassembly further includes:
a clevis pivotally connected to the crank; and
an equalizer pivotally connected to the clevis, whereby depression of the brake pedal causes the brake pedal shaft and crank to rotate thereby pulling the brake cables connected to the equalizer.

22. A utility vehicle, said vehicle comprising:
a prime mover adapted to deliver torque to affect movement of the vehicle;
a braking assembly adapted to apply frictional forces to impede rotation of at least one wheel of the vehicle; and
a modular accelerator and brake (A&B) assembly adapted to control the operation of the prime mover and the braking assembly, said modular A&B assembly including:
a mounting plate including a lip formed around a perimeter of the mounting plate adapted to fit within a recess formed in a floor structure of the vehicle to thereby form a barrier to liquids and debris penetrating a joint formed between the lip and the recess;
an accelerator pedal subassembly including an accelerator pedal coupled to an accelerator pedal arm coupled to an accelerator pedal shaft rotationally mounted within a pair of opposing apertures in a pair of accelerator mounts extending from an underside of the mounting plate;
a brake pedal subassembly including brake pedal coupled to a brake pedal arm coupled to a brake pedal shaft rotationally mounted within a pair of opposing apertures in a pair of brake mounts extending from the underside of the mounting plate, wherein an axis of the accelerator pedal shaft is offset from an axis of the brake pedal shaft; wherein
the modular A&B assembly is further adapted to mount to a frame structure of the vehicle such that the accelerator subassembly is located on one side of the frame structure and the brake subassembly is located on an opposing side of the frame structure.

23. The vehicle of claim 22, wherein the vehicle further includes a mounting plate cover adapted to be positioned over an upper surface of the mounting plate when the mounting plate lip is fitted within the floor structure recess to thereby provide a substantially smooth continuation of the upper surface of the floor structure across the modular A&B assembly, and to provide a barrier to liquids and debris infiltrating the floor structure recess.

24. The vehicle of claim 22, wherein the vehicle further includes an undercarriage pan connected to a plurality of stand-offs extending from the underside of the mounting plate and including a lip that substantially forms a seal with an underside of a floor structure of the vehicle, whereby the undercarriage pan covers an underside of the modular A&B assembly to protect the modular A&B assembly from infiltration of and damage from ground liquids, objects and debris.

25. The vehicle of claim 24, wherein the vehicle further includes a splash shield extending from the underside of the floor structure around a perimeter of the undercarriage pan lip, the splash shield adapted to provide a barrier to liquids, objects and debris infiltrating a joint formed between the lip and the floor structure.

26. The vehicle of claim 22, wherein the vehicle further includes an undercarriage pan comprising a cavity formed within the floor structure, whereby the undercarriage pan covers an underside of the modular A&B assembly to protect the modular A&B assembly from infiltration of and damage from ground liquids, objects and debris.

27. The vehicle of claim 22, wherein the modular A&B assembly is further adapted to mount to the frame structure such that the accelerator pedal is a first orthogonal distance from a center line of the vehicle and the brake pedal is a second orthogonal distance from the center line to thereby ergonomically locate the accelerator and brake pedals for a driver sitting in a driver's seat of the vehicle.

28. The vehicle of claim 27, wherein the offset of the accelerator and brake axes is adapted to locate the accelerator pedal a first longitudinal distance from a driver seat base of the vehicle and the brake pedal a second longitudinal distance from the driver seat base to thereby ergonomically locate the accelerator and brake pedals for the driver.

29. The vehicle of claim 28, wherein the accelerator pedal is mounted on the accelerator pedal arm such that a face of the accelerator pedal forms a first angle with respect to a floor structure of the vehicle and the brake pedal is mounted on the brake pedal arm such that a face of the brake pedal forms a second angle with respect to the floor structure, whereby the first and second angles ergonomically orient the accelerator and brake pedals to the driver.

30. The vehicle of claim 22, wherein the accelerator pedal subassembly includes:
an accelerator pedal position sensor coupled to one of the accelerator mounts and cooperative with the accelerator pedal to output an accelerator sensor signal proportional to an amount of displacement of the accelerator pedal; and
a throttle enable switch adapted to generate a control signal used to enable and disable operation of the vehicle.

31. The vehicle of claim 22, wherein the brake pedal subassembly includes:
a brake pedal position sensor coupled to one of the brake mounts and cooperative with the brake pedal shaft to output a brake sensor signal utilized to induce a regenerative braking torque on the prime mover that is proportional to an amount of displacement of the brake pedal;
a full stroke switch adapted to generate a control signal the execute a parking brake operation when the brake pedal is depressed to at least a predetermined position; and
an bias device adapted to return the brake pedal to a non-depressed position and provide a progressive resistive force during depression of the brake pedal.

32. The vehicle of claim 22, wherein the brake pedal subassembly includes a bushing adapted to provide a cushioned stop when the brake pedal is depressed to a full stroke position.

33. The vehicle of claim 22, wherein the brake pedal subassembly includes:
a pair of ratchet tooth pawls affixed to an inner side of each of the brake mounts, each of the pawls comprising a plurality of ratchet teeth;
a latch pin extending through opposing slots in opposing sides of a U-channel brake pedal arm coupled to the brake pedal shaft and extending between the ratchet tooth pawls;
a engagement mechanism slidably mounted within the U-channel brake pedal arm and having the latch pin extending therethrough such that the engagement mechanism is adapted to move the latch pin within the opposing slots; and
a connecting rod having a first end retained operatively connected to a first end of the engagement device and a second end attached to a park brake pedal such that depression of the park brake pedal displaces the connecting rod causing the engagement mechanism to move the latch pin within the opposing slots and engage the ends of the latch pin with longitudinally aligned sets of teeth of the ratchet tooth pawls, whereby the latch pin ends are frictionally retained within the teeth to thereby maintain a mechanical friction brake mechanism of the braking assembly a actuated position.

34. The vehicle of claim 33, wherein the modular A&B assembly further includes a bell crank pivotally mounted to the underside of the mounting plate, the bell crank connected at a first end, via a first tie rod, to the disengaging cam rotatably mounted on the brake pedal shaft, the bell crank connected, via a second tie rod, at a second end to a ball stud coupled to the accelerator pedal shaft such that rotation of the accelerator pedal shaft causes the bell crank to rotate the disengaging cam about the brake pedal shaft to thereby disengage the latch pin from the ratchet tooth pawls.

35. The vehicle of claim 34, wherein the brake pedal subassembly further includes:
a crank coupled to an end of the brake pedal shaft;
a clevis pivotally connected to the crank; and
an equalizer pivotally connected to the clevis, whereby depression of the brake pedal causes the brake pedal shaft and crank to rotate thereby pulling brake cables connected to the equalizer and the mechanical friction brake mechanism.

36. A method for controlling movement of a utility vehicle, said method comprising:
controlling operational commands to a vehicle prime mover utilizing an accelerator pedal subassembly of a modular accelerator and brake (A&B) assembly having an accelerator pedal shaft rotationally mounted within a pair of opposing apertures within a pair of accelerator mounts extending from an underside of a mounting plate coupled to a frame structure of the vehicle such that the accelerator subassembly is located on a first side of the frame structure; and
controlling operational commands to at least one of a vehicle braking assembly and the vehicle prime mover utilizing a brake pedal subassembly of the modular A&B assembly having a brake pedal shaft rotationally mounted within a pair of opposing apertures in a pair of brake mounts extending from the underside of the mounting plate such that an axis of the brake pedal shaft is offset from an axis of the accelerator pedal shaft and such that the brake pedal subassembly is located on a second side of the frame structure; wherein
the mounting plate mates with a floor structure of the vehicle such that a lip formed around a perimeter of the mounting plate is fitted within a recess formed in a floor structure of the vehicle to form a barrier to liquids, objects and debris penetrating a joint formed between the lip and the recess.

37. The method of claim 36, wherein the method further includes positioning a mounting plate cover over an upper surface of the mounting plate when the mounting plate lip is fitted within the floor structure recess to thereby provide a substantially smooth continuation of the an upper surface of the floor structure across the modular A&B assembly and to provide a barrier to liquids, objects and debris infiltrating the floor structure recess.

38. The method of claim 36, wherein the method further includes connecting an undercarriage pan to a plurality of stand-offs extending from the underside of the mounting plate thereby covering an underside of the modular A&B assembly to protect the modular A&B assembly from infiltration of and damage from ground liquids, objects and debris.

39. The method of claim 36, wherein the method further includes forming a cavity within the floor structure, whereby the cavity covers an underside of the modular A&B assembly to protect the modular A&B assembly from infiltration of and damage from ground liquids, objects and debris.

40. The method of claim 36, wherein the method further comprises coupling the mounting plate to the frame structure such that an accelerator pedal coupled to an accelerator pedal arm coupled to the accelerator pedal shaft is a first orthogonal distance from a center line of the vehicle and a brake pedal coupled to a brake pedal arm coupled to the brake pedal shaft is a second orthogonal distance from the center line thereby ergonomically locating the accelerator and brake pedals for a driver sitting in a driver's seat of the vehicle.

41. The method of claim 40, wherein coupling the mounting plate to the frame structure further comprises offsetting the accelerator and brake axes such that the accelerator pedal is located a first longitudinal distance from a driver seat base of the vehicle and the brake pedal is located a second longitudinal distance from the driver seat base thereby ergonomically locating the accelerator and brake pedals for the driver.

42. The method of claim 40, wherein the accelerator pedal is mounted on the accelerator pedal arm such that a face of the accelerator pedal forms a first angle with respect to a floor structure of the vehicle and the brake pedal is mounted on the brake pedal arm such that a face of the brake pedal forms a second angle with respect to the floor structure, whereby the first and second angles ergonomically orient the accelerator and brake pedals to the driver.

43. The method of claim 36, wherein controlling operational commands to a vehicle prime mover utilizing the accelerator pedal subassembly further comprises
outputting an accelerator sensor signal from an accelerator pedal position sensor interactive with the accelerator pedal, wherein the accelerator sensor signal is proportional to an amount of displacement of the accelerator pedal, thereby controlling acceleration and deceleration of the vehicle; and
controlling enablement of operation of the vehicle utilizing a throttle enable switch included in the accelerator pedal subassembly.

44. The method of claim 36, wherein controlling operational commands to at least one of the vehicle braking assembly and the vehicle prime mover utilizing a brake pedal subassembly further comprises:
outputting a brake sensor signal from a brake pedal position sensor coupled to one of the brake mounts and interactive with the brake pedal shaft, wherein the brake sensor signal is utilized to induce a regenerative braking torque on the prime mover that is proportional to an amount of displacement of the brake pedal;
activating an electronically controlled friction brake mechanism of the braking assembly, utilizing a full stroke switch included in the brake pedal subassembly, when a brake pedal of the brake pedal subassembly is depressed to a position that is within a specified percentage of a maximum brake pedal stroke;
providing a progressive resistive force during depression of the brake pedal utilizing an active force feedback device included in the brake pedal subassembly; and
providing a cushioned stop when the brake pedal is depressed to a full stroke position utilizing the active force feedback device.

45. The method of claim 36, wherein controlling operational commands to at least one of the vehicle braking assembly and the vehicle prime mover utilizing a brake pedal subassembly further comprises frictionally retaining opposing ends of a latch pin within teeth of a pair of ratchet tooth pawls to maintain a mechanical friction brake mechanism of the braking assembly in an actuated position, wherein the ratchet tooth pawls are affixed to an inner side of the brake mounts and the latch pin extends through opposing slots in opposing sides of a U-channel brake pedal arm coupled to the brake pedal shaft and extending between the ratchet tooth pawls.

46. The method of claim 45, wherein frictionally retaining opposing ends of the latch pin within teeth of the ratchet tooth pawls comprises:
depressing a park brake pedal to displace a connecting rod having a first end retained within an upper end of a collar of a dual spring engagement mechanism and a second end attached to a park brake pedal, wherein the dual spring engagement mechanism is slidably mounted within the U-channel brake pedal arm and the latch pin extends through the collar; and
moving the collar via the displacement of the connecting rod, thereby moving the latch pin within the opposing slots and engaging the ends of the latch pin with longitudinally aligned sets of teeth of the ratchet tooth pawls.

47. The method of claim 46, wherein the method further comprises disengaging the latch pin from the ratchet tooth pawls by depressing an accelerator pedal to rotate a disengaging cam rotatably mounted on the brake pedal shaft such that the disengaging cam moves a piston rod of the dual spring engagement mechanism, thereby disengaging the latch pin from the ratchet tooth pawls, wherein the disengaging cam is connected, via a first tie rod, to a first end of bell crank pivotally mounted to the underside of the mounting plate, and a second end of the bell crank is connected, via a second tie rod, to a ball stud coupled to the accelerator pedal shaft which is rotated by depression of the accelerator pedal.

48. The method of claim 36, wherein controlling operational commands to at least one of the vehicle braking assembly and the vehicle prime mover utilizing a brake pedal subassembly further comprises pulling brake cables connected to an equalizer of the brake pedal subassembly and a mechanical friction brake mechanism of the braking assembly, wherein the equalizer is pivotally connected to a clevis that is pivotally connected to a crank coupled to an end of the brake pedal shaft such that depression of a brake pedal causes the brake pedal shaft and crank to rotate thereby pulling the brake cables.
